(19) United States
(12) Patent Application Publication
(10) Pub. No.: US 2024/0210993 A1
(43) Pub. Date: Jun. 27, 2024

(54) ELECTRONIC DEVICE INCLUDING A HYBRID HOUSING ASSEMBLY

(71) Applicant: Apple Inc., Cupertino, CA (US)

(72) Inventor: Drake W. Stacy, Austin, TX (US)

(21) Appl. No.: 18/516,839

(22) Filed: Nov. 21, 2023

Related U.S. Application Data
(60) Provisional application No. 63/434,609, filed on Dec. 22, 2022.

(51) Int. Cl. G06F 1/16

(52) U.S. Cl. CPC G06F 1/1637; G06F 1/1616

(57) ABSTRACT

An electronic device enclosure including a housing assembly is described. The housing assembly may include a composite housing component. For example, the housing assembly may include a housing component formed at least in part from a metal and coupled to a composite housing component at least in part by a metal joining element included in the composite housing component. Electronic devices including these enclosures are also described.

### CROSS-REFERENCE TO RELATED APPLICATIONS

This application is a nonprovisional application of and claims the benefit of U.S. Provisional Patent Application No. 63/434,609, filed Dec. 22, 2022, and titled “Electronic Device Including A Hybrid Housing Assembly,” the disclosure of which is hereby incorporated herein by reference in its entirety.

### FIELD

The described embodiments relate generally to electronic devices. More particularly, the present embodiments relate to electronic devices and electronic device enclosures that include housing assemblies with a composite housing component.

### BACKGROUND

Some conventional consumer electronic devices include an enclosure that surrounds one or more internal electronic components of the device. For example, some conventional electronic devices include a display that is positioned within the enclosure and viewable through a transparent window defined by the enclosure. In some cases, the electronic device may be provided in a portable form factor, such as a laptop computer.

### SUMMARY

Aspects of the following disclosure relate to electronic device enclosures and electronic devices including these enclosures. The electronic device enclosure may include a housing assembly that includes a composite housing component. For example, the housing assembly may include a housing component that defines exterior side surfaces of the enclosure and that is formed at least in part from a metal. The housing assembly may also include a composite housing component that is joined to an interior surface of the housing component. The electronic device enclosure may also include front and rear cover assemblies joined to the housing component. In some cases, the enclosure is a display portion of a laptop.

The composite housing components of the housing assemblies described herein may provide the enclosure with a balance between weight and structural properties such as strength and/or stiffness. In some embodiments, the composite housing component has the form of a composite structure that includes a stack of polymer composite layers integrated with a metal joining element. The metal joining element may be laminated with the stack of polymer composite layers. As examples, the composite structure may be in the form of a plate-like structure or a web-like structure. When the stack of polymer composite layers makes up most of the composite structure, the weight of the composite structure may be less than that of a metal structure of like dimensions while still providing adequate stiffness (e.g., resistance to bending or twisting) to the enclosure.

The housing assemblies described herein may be referred to as “hybrid” housing assemblies because they include both composite and metal materials. In embodiments, the housing assemblies described herein provide a strong bond between the composite structure and the metal portions of the housing component. In some cases, the integration of a metal joining element into the composite structure can facilitate joining of the composite structure to the housing component using techniques such as solid-state welding, mechanical bonding, or the like. Furthermore, the bonds produced using such techniques may allow the metal portions of the housing component to be anodized after, rather than before, the housing assembly is formed, which can lead to process efficiencies.

The disclosure provides an electronic device comprising an enclosure defining an internal cavity and comprising a housing component defining a set of exterior side surfaces of the electronic device and an internal ledge that extends into the internal cavity of the enclosure, a composite structure positioned within the internal cavity and comprising a first sheet formed from a first polymer composite material, a second sheet formed from a second polymer composite material, and a metal joining element comprising a first portion positioned between the first sheet and the second sheet, and a second portion extending from between the first sheet and the second sheet and attached to the internal ledge of the housing component, and a cover member coupled to the housing component. The electronic device further comprises a display positioned within the internal cavity and under the cover member.

The disclosure also provides an electronic device comprising a display and an enclosure at least partially surrounding the display and comprising a first transparent member positioned over the display and defining a front exterior surface of the electronic device, a second transparent member defining a rear exterior surface of the electronic device, a housing component coupled to the first and the second transparent members and defining a set of side exterior surfaces of the electronic device, and a composite structure comprising a first set of polymer composite layers defining a first edge, a second set of polymer composite layers defining a second edge, and a metal joining element comprising a first portion disposed between the first and the second sets of polymer composite layers, and a second portion extending beyond the first and the second edges and coupled to the housing component.

The disclosure also provides an electronic device comprising an enclosure defining an internal cavity and comprising a housing component defining an exterior surface of the electronic device and an interior ledge, a composite structure positioned within the internal cavity and comprising a stack of composite layers comprising fibers in a polymer matrix, and a metal joining element comprising a first portion positioned within the stack of composite layers, and a second portion extending from the stack of composite layers and coupled to the interior ledge, and a cover member coupled to the housing component, and a display positioned within the internal cavity and under the cover member.

### BRIEF DESCRIPTION OF THE DRAWINGS

The disclosure will be readily understood by the following detailed description in conjunction with the accompanying drawings, wherein like reference numerals designate like elements.

FIGS. 1A, 1B, and 1C show an example electronic device.

FIG. 2 shows an exploded view of a portion of the electronic device of FIGS. 1A and 1B.

FIG. 3 shows an exploded view of an example of a housing assembly.

FIG. 4 shows an example of a metal joining element.

FIG. 5 shows another example of a metal joining element.

FIG. 6 shows another example of a metal joining element.

FIG. 7 shows a top view of a composite structure.

FIG. 8 shows a partial cross-sectional view of a composite structure.

FIG. 9 shows an example of an enlarged view of a housing assembly.

FIG. 10 shows another example of an enlarged view of a housing assembly.

FIG. 11 shows an example of a partial cross-sectional view through a housing assembly.

FIG. 12 shows another example of a partial cross-sectional view through a housing assembly.

FIG. 13 shows another example of a partial cross-sectional view through a housing assembly.

FIG. 14 shows another example of a partial cross-sectional view through a housing assembly.

FIG. 15 shows a block diagram of an example electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred implementation. To the contrary, the described embodiments are intended to cover alternatives, modifications, and equivalents as can be included within the spirit and scope of the disclosure and as defined by the appended claims.

Aspects of the following disclosure relate to electronic device enclosures and electronic devices including these enclosures. The electronic device enclosure may include a housing assembly that includes a composite housing component. For example, the housing assembly may include a housing component that defines exterior side surfaces of the enclosure and that is formed at least in part from a metal. The housing assembly may also include a composite housing component that is joined to an interior surface of the housing component. The electronic device enclosure may also include front and rear cover assemblies joined to the housing component. In some cases, the enclosure is a display portion of a laptop.

The composite housing components of the housing assemblies described herein may provide the enclosure with a balance between weight and structural properties such as strength and/or stiffness. In some embodiments, the composite housing component has the form of a composite structure that includes a stack of polymer composite layers integrated with a metal joining element. The metal joining element may be laminated with the stack of polymer composite layers. As examples, the composite structure may be in the form of a plate-like structure or a web-like structure. When the stack of polymer composite layers makes up most of the composite structure, the weight of the composite structure may be less than that of a metal structure of like dimensions while still providing adequate stiffness (e.g., resistance to bending or twisting) to the enclosure.

The housing assemblies described herein may be referred to as “hybrid” housing assemblies because they include both composite and metal materials. For example, the composite material may include at least one material other than a metal material, such as a polymer matrix or binder and/or a non-metallic reinforcement material. In embodiments, the housing assemblies described herein provide a strong bond between the composite structure and the metal material of the housing component. In some cases, the integration of a metal joining element into the composite structure can facilitate joining of the composite structure to the housing component using techniques such as solid-state welding, mechanical bonding, or the like. Furthermore, the bonds produced using such techniques may allow the housing component to be anodized after, rather than before, the housing assembly is formed, which can lead to process efficiencies.

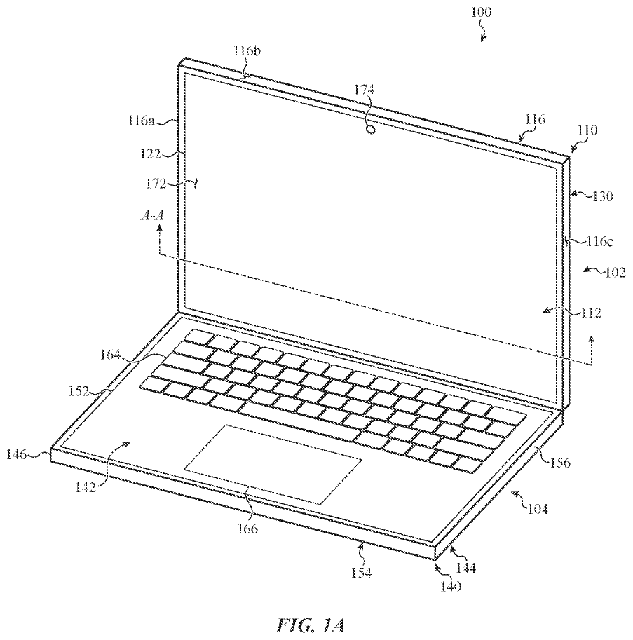

These and other embodiments are discussed below with reference to FIGS. 1A-15. However, those skilled in the art will readily appreciate that the detailed description given herein with respect to these figures is for explanatory purposes only and should not be construed as limiting.

FIGS. 1A and 1B show an example electronic device. The electronic device 100 may be a computing device such as a portable computer, which may also be referred to as a laptop or notebook computer. In other examples, the electronic device may be another form of computing device, such as a tablet computing device, a display monitor, or any other suitable electronic device.

In the example of FIGS. 1A and 1B, the electronic device 100 includes a display portion 102 and a base portion 104. The display portion 102 is flexibly coupled to the base portion 104. For example, the display portion 102 may be coupled to the base portion through a hinge or other suitable mechanism to allow the display portion 102 to rotate, pivot, or otherwise flex with respect to the base portion 104.

The display portion 102 includes a display assembly 172. In some cases, the display assembly 172 may be a touch screen display assembly that includes both a display and a touch sensor. The display assembly 172 is positioned within the first enclosure 110. The display portion also includes an optical assembly 174 that is at least partially positioned within the first enclosure 110. The optical assembly 174 may include a camera module.

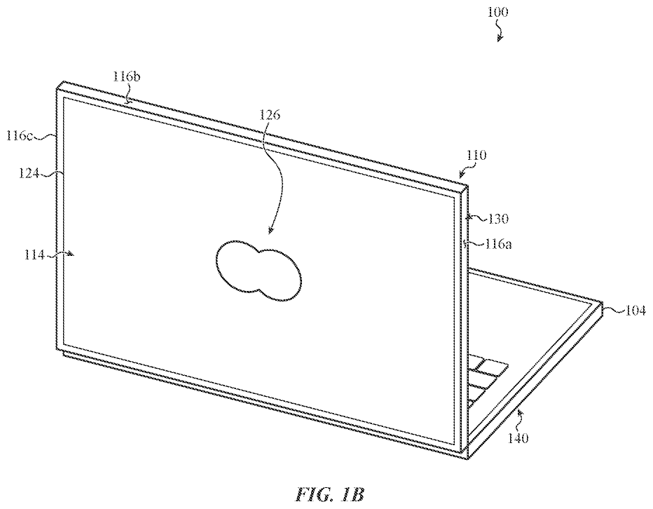

The first enclosure 110 includes a housing assembly 130, a front cover assembly 122, and a rear cover assembly 124. The front cover assembly 122 may define a transparent portion through which graphical output from the display assembly 172 may be viewed. Each of the front cover assembly 122 and the rear cover assembly 124 may be coupled to the housing assembly as described in more detail with respect to FIGS. 1C and 2 and that description is not repeated here.

The front cover assembly 122 may define at least a portion of the front surface 112 of the enclosure 110. The front surface 112 may also be referred to herein as a front exterior surface. As shown in FIG. 1A, the front cover assembly 122 is positioned over the display assembly 172. The front cover assembly 122 may include a front cover member 123 which may be formed from a glass material, a glass ceramic material, a polymer material, or combinations thereof. For example, the front cover member 123 may include layers of glass and/or glass ceramic material bound together with a polymer material. In some cases, the front cover member 123 is formed of an ion-exchangeable material and the front cover member is ion-exchanged to form a compressive stress layer along one or more surfaces of the front cover member. The front cover member 123 may be wholly transparent so that it is a transparent member or it may include or include a transparent portion over the display assembly. The front cover member 123 may extend laterally across the front cover assembly, such as substantially across the width and the length of the front cover assembly 122. In some examples, the front cover member 123 may have a thickness greater than 0.3 mm and less than 2 mm, from 0.3 mm to less than 1 mm, or from 0.3 mm to 0.6 mm. In some instances, the front cover assembly 122 may include a coating along a portion of an interior surface of the front cover member 123 in order to mask or obscure interior components of the electronic device from view and/or to provide a decorative effect. For example, the coating may be opaque.

The rear cover assembly 124 may define at least a portion of the rear surface 114 of the enclosure 110. The rear surface 114 may also be referred to herein as a rear exterior surface. The rear cover assembly 124 may include a rear cover member 125 which may be formed from a glass material, a glass ceramic material, a polymer material, or combinations thereof. For example, the rear cover member 125 may include layers of glass and/or glass ceramic material bound together with a polymer material. In some cases, the rear cover member 125 is formed of an ion-exchangeable material and the rear cover member is ion-exchanged to form a compressive stress layer along one or more surfaces of the rear cover member. The rear cover member 125 may be wholly transparent so that it is a transparent member or it may include a transparent portion. The rear cover assembly 124 may further include a coating along an interior surface of the rear cover member 125 that is similar to the coating previously discussed with respect to the front cove assembly 122. In some instances, the thickness of the rear cover member 125 may be similar to the thicknesses of the front cover member described above. The rear cover member 125 may extend laterally across the rear cover assembly 124, such as substantially across the width and the length of the rear cover assembly 124. As shown in FIG. 1B, the rear cover assembly may define an indicium 126, such as a logo, a graphic, text, or the like.

The housing assembly 130 at least partially defines an exterior side surface 116 of the enclosure 110. As shown in FIGS. 1A and 1B, the exterior side surface 116 includes a set of exterior side surfaces 116a, 116b, and 116c. In embodiments, the housing assembly 130 includes a housing component 132 that is formed at least in part from a metal (see FIG. 1C) and a composite structure 134 (see FIG. 1C). The composite structure 134 may alternately be referred to herein as a composite housing component or simply as a composite component. The composite structure 134 is coupled to the housing component 132.

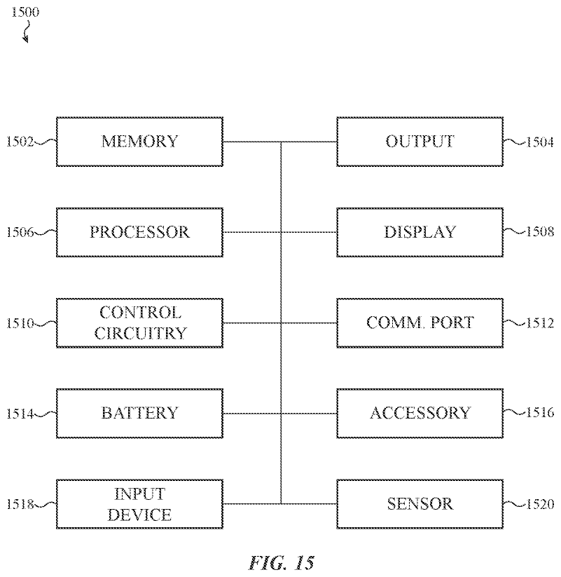

As shown in FIGS. 1A and 1B, the base portion 104 includes multiple input devices, including a keyboard 164 and a trackpad 166. The base portion 104 also typically includes internal electronic device components. These electronic device components may be all or some of the device components described with respect to FIG. 15. In addition to the input devices already described, the device components may include one or more of a battery, a logic board, a processor, memory, a haptic device, a communication port, a charging port, battery charging circuitry and the like.

The second enclosure 140 of the base portion 104 may be flexibly coupled to the first enclosure 110 of the display portion 102. As shown in the example of FIGS. 1A and 1B, the second enclosure 140 includes a housing component 156 that at least partially defines an exterior side surface 146 of the second enclosure 140. The second enclosure 140 also includes a top structure 152 that defines at least a portion of an upper surface 142 of the enclosure 140. In some examples, the top structure 152 defines one or more holes or openings to allow access to the keyboard and/or trackpad region. In some instances, the housing component 156 also at least partially defines a lower surface 144 of the second enclosure 140. In other instances, the second enclosure 140 further includes a bottom structure that is coupled to the housing component 156 and at least partially defines the lower surface 144 of the second enclosure 140. In some cases, the lower surface 144 may rest on a work surface during use of the electronic device 100 while in other cases one or more supports (“feet”) may be attached to the lower surface 144.

FIG. 1C shows an example of a partial cross-sectional view of the first enclosure 110. For example, the view of FIG. 1C may be of the left side of the first enclosure 110 as shown in FIG. 1A along the section line A-A. As shown in FIG. 1C, the housing assembly 130 of the first enclosure 110 includes a housing component 132 and a composite structure 134. The composite structure 134 is coupled to an attachment feature 182 of the housing component 132. An attachment feature positioned along an interior surface of the housing component, such as the attachment feature 182, may also be referred to herein as an interior attachment feature. In the example of FIG. 1C, the attachment feature 182 defines a ledge as described in more detail below.

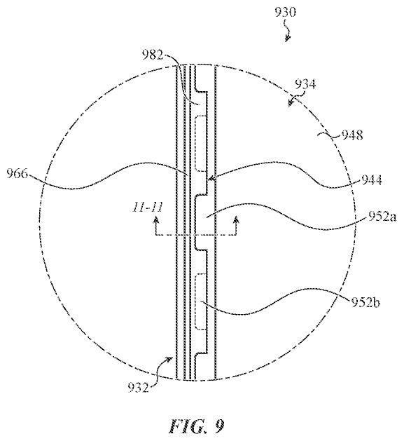

The housing component 132 defines a ledge 182 that extends into an internal cavity 101 of the enclosure 110. The composite structure 134 comprises a metal joining element 144 and the metal joining element 144 is attached to the ledge 182. As shown in the example of FIG. 1C, the metal joining element 144 is attached to both the front surface 183 and the rear surface 184 of the ledge 182. Further description of how this type of attachment may be achieved is provided with respect to FIGS. 9-13 and that description is not repeated here. The example of FIG. 1C is not limiting and in additional examples the metal joining element may be attached only to the front surface of the ledge, only to the rear surface of the ledge, or may be attached to another form of attachment feature. Additional description of the metal joining element 144 is provided with respect to FIGS. 2-13 and that description is not repeated here.

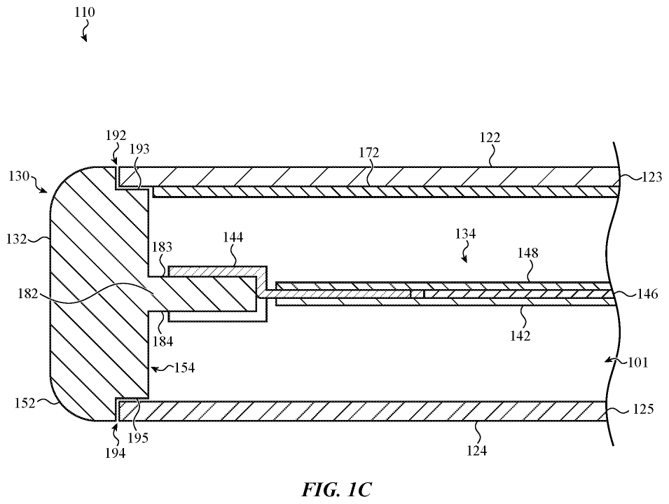

The composite structure 134 also includes a first set of polymer composite layers 142, a second set of polymer composite layers 148, and a third set of polymer composite layers 146. The first set of polymer composite layers 142 may define a first sheet, the second set of polymer composite layers 148 may define a second sheet, and a third set of polymer composite layers 146 may define a third sheet. In some instances, the first sheet may be formed of a first polymer composite material, the second sheet may be formed of a second polymer composite material, and the third sheet may be formed of a third polymer composite material. The first, second, and third polymer composite materials may be the same or two or more of these polymer composite materials may differ. As shown in the example of FIG. 1C, a first portion of the metal joining element is positioned between the first and the second sets of polymer composite layers 142 and 148. A second portion of the metal joining element 144 is attached to the ledge 182. The second portion of the metal joining element may be contiguous with the first portion. Further description of the polymer composite layers and the assembly of these layers with the metal joining element is provided at least with respect to FIGS. 2-3 and that description is not repeated here.

The housing component 132 further defines a first opening 192 at the front of the enclosure 110 and the front cover assembly 122 is positioned within the first opening 192. The housing component 132 also defines a second opening 194 at the rear of the enclosure 110 and the rear cover assembly 124 is positioned within the rear opening 194. Each of the first opening 192 and the second opening 194 may be an opening to the interior cavity 101. The interior surface 154 of the housing component 132 may define a perimeter, such as a perimeter of the internal cavity 101. The housing component 132 further defines a front support 193 for the front cover assembly 122 and a rear support 195 for the rear cover assembly. The ledge 182 is positioned along the interior surface 154 of the housing component 132 between the front and rear supports 193 and 195. The exterior surface 152 of the housing component at least partially defines the exterior side surface 116 of the enclosure 110 (see FIG. 1A).

FIG. 2 shows an exploded view of a portion of the electronic device of FIGS. 1A, 1B, and 1C. For example, the exploded view of the enclosure 210 may be an example of an exploded view of the enclosure 110 of the display portion 102 of FIGS. 1A-1C.

As shown in FIG. 2, the enclosure 210 includes a front cover assembly 222, a rear cover assembly 224, and a housing assembly 230. As previously described with respect to FIG. 1A, the front cover assembly 222 may be positioned over a display assembly of the electronic device and both the front cover assembly 222 and the rear cover assembly 224 may be coupled to the housing assembly 230 as described in more detail below.

The housing assembly 230 includes a housing component 232 and a composite structure 234, also referred to herein as a composite housing component. In the example of FIG. 2, the housing component 232 forms a band-like structure. The housing component 232 is formed at least in part from a metal. In some examples, the housing component is formed from a metal and may be referred to as a metal housing component. The housing component may be formed from a single member (e.g., a member formed from a single piece of metal) or may comprise multiple members. In some examples, the housing component may comprise a metal member and a dielectric member. For example, a dielectric member may be provided between adjacent metal members of the housing component. The dielectric members may be formed from one or more dielectric materials such as a polymer, a ceramic, or a glass. The exterior surface 252, the interior surface 254, the front surface 256, and the rear surface 258 of the housing component 232 are also shown in FIG. 2. As referred to herein, a housing component or member formed from a metal can also include a thin coating such as an anodization layer or a vacuum deposited coating on the exterior surface of the housing component. The description of housing components provided with respect to FIG. 2 is generally applicable herein.

In the example of FIG. 2, the composite structure 234 is plate-like in form. Therefore, in some examples the composite structure 234 defines a plate or platform. However, this example is not limiting and in additional examples, the composite structure may define one or more holes and therefore may be referred to as a “web.” The plate or platform may generally separate the internal cavity into different regions, although holes in the composite structure may allow internal device components and/or connecting elements to extend from one region of the internal cavity to another.

As described in more detail with respect to FIG. 3, the composite structure 234 may include a stack of polymer composite layers. A polymer composite layer may include a polymer material that serves as a matrix or binder and another material that is different from this polymer material, as explained in more detail below. In some embodiments, the thickness of the composite structure 234 may range from 1 mm to 3 mm, from 1 mm to 2 mm, or from 0.75 mm to 2.5 mm. In additional embodiments, the composite structure 234 may have a thickness from 2 mm to 10 mm or from 5 mm to 15 mm. The composite structure may serve as a support for at least one internal device component, as described in more detail below.

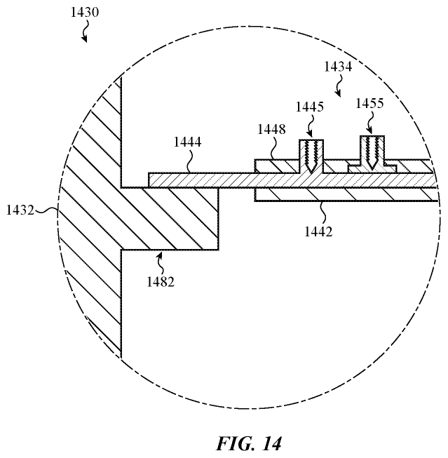

The internal device component may be coupled to the composite structure 234 with a mechanical connection and/or using an adhesive or other bonding agent. In some cases, the composite structure may include one or more coupling features that facilitate coupling of the internal device component to the composite structure. As non-limiting examples, these coupling features may be defined by the metal joining element or may be individual coupling features, such as bosses or inserts, that are at least partially embedded in the stack of polymer composite layers. In some cases, the coupling feature may be internally threaded. In other cases, the coupling feature does not provide a threaded connection but facilitates soldering or otherwise adhering the internal device component to the coupling feature. Individual coupling features that are not defined by the metal joining element may be formed of a metal material which is different from the metal material used to form the metal joining element. The additional description of coupling features provided with respect to FIG. 14 is generally applicable herein and is not repeated here.

In some embodiments, each polymer composite layer of the stack of polymer composite layers may be a fiber-reinforced polymer material. The fiber-reinforced polymer material may comprise fibers in a polymer matrix or binder. Examples of fiber-reinforced polymer materials include, but are not limited to, a polymer material reinforced with one or more of carbon fibers, aramid fibers, glass fibers, ceramic fibers or the like. When the fibers are continuous rather than chopped, the fibers in a given layer may be generally aligned. In some instances, different layers of the stack have different fiber orientations in order to provide the desired structural properties. The polymer material may be any suitable polymer material including thermoset or thermoplastic polymer materials. Suitable thermoset materials include, but are not limited to, epoxy-based resins, unsaturated polyester resins, and vinyl ester resins. In some embodiments, the thickness of each individual layer ranges from 30 micrometers to 300 micrometers. The thicknesses of the layers may be the same or may be different. The additional description of polymer composite layers provided with respect to FIGS. 3 and 7-8 is generally applicable herein and is not repeated here.

In embodiments, the composite structure 234 also includes a metal joining element. The metal joining element (e.g., 144 in FIG. 1C) may be formed from any suitable metal, including, but not limited to, steel, a titanium alloy, an aluminum alloy, or a combination thereof. The metal joining element may have a thickness in a range from 0.5 mm to 2 mm, from 1 mm to 5 mm, or from 2 mm to 10 mm. In some cases, the thickness of the metal joining element is uniform to within 10%.

A first portion of the metal joining element is positioned within the stack of polymer composite layers. The first portion of the metal joining element may be integrated into the stack of polymer composite layers at least in part by using an adhesive (which in some cases may be the polymer resin of the polymer composite) to bond the metal joining element to adjacent polymer composite layers. In some examples, the metal joining element may be laminated with the stack of polymer composite layers. In some instances, the metal joining element may include features that mechanically interlock with the adhesive. A second portion of the metal joining element protrudes from the stack of polymer composite layers, as described in greater detail with respect to FIGS. 1C, 3 and 7-13. The second portion of the metal joining element may be contiguous with the first portion. The additional description of metal joining elements provided with respect to FIGS. 1C, 3-13 is generally applicable herein and is not repeated here.

The composite structure 234 is coupled to the housing component 232 in the as-assembled housing assembly. The second (protruding) portion of the metal joining element may be coupled (e.g., bonded) to a metal member of the housing component 232. In embodiments, the second (protruding) portion of the metal joining element is coupled to an interior surface of the housing component, examples of which are shown and described with respect to FIGS. 9-13. In some instances, the composite structure 234 is positioned with respect to the housing component 232 so that the composite structure 232 defines a mid-plate.

In some cases, the housing component 232 defines a ledge, a shelf, or another type of attachment feature along its interior surface and the second portion of the metal joining element is coupled to the ledge, shelf, or other attachment feature (e.g., ledge 182 of FIG. 1C). These attachment features may also be referred to herein as internal or interior attachment features. For example, the metal joining element may be coupled to a metal ledge defined by a metal portion of the housing component (e.g., a metal member of the housing component). One or more metal members of the housing component may be formed from an aluminum alloy, a titanium alloy, a steel, or a combination thereof. In some embodiments, the metal joining element may be formed from steel, a titanium alloy, or an aluminum alloy and the metal of the ledge (and the housing component) may be an aluminum alloy, a titanium alloy, or a steel. In some cases, the metal joining element and the ledge may be formed from the same kind of metal. In other cases, the metal of the metal joining element is different from the metal of the ledge. Techniques suitable for bonding dissimilar metals include, but are not limited to, solid-state welding, formation of mechanical interlocks, and the like. Alternately or additionally, an adhesive material may be used to couple the metal joining element to the housing component. The description of techniques for coupling a composite structure to a housing component described with respect to FIG. 2 is generally applicable herein. The additional description of techniques for coupling composite structures to housing components provided with respect to FIG. 9-13 is also generally applicable herein.

As previously mentioned, each of the front cover assembly 222 and the rear cover assembly 224 may be coupled to the housing assembly 230. In some instances, the front cover assembly 222 and the rear cover assembly 224 may be coupled to the housing component 232, the composite structure 234, or both. For example, the housing component 232 may define a front ledge to which the front cover assembly 222 is bonded and/or the housing component 232 may define a rear ledge to which the rear cover assembly 224 is bonded (e.g., using an adhesive). As another example, one or more of the front cover assembly 222 and the rear cover assembly 224 may be coupled to the composite structure using one or more of an adhesive, a mechanical interlock, or another suitable coupling feature. In some cases, the front surface 212 defined by the front cover assembly 222 is flush or substantially flush with the front surface 256 of the housing component 232. Similarly, the rear surface 214 defined by the rear cover assembly 224 may be flush with the rear surface 258 of the housing component 232.

FIG. 3 shows an exploded view of an example of a housing assembly. The housing assembly 330 may be an example of the housing assembly 230 or the housing assembly 130. The housing assembly 330 includes a housing component 332 and a composite structure 334.

In the example of FIG. 3, the composite structure 334 includes a first set of polymer composite layers 342, a metal joining element 344, a second set of polymer composite layers 348, and a third set of polymer composite layers 346. The first, second, and third sets of polymer composite layers may define an assembly of polymer composite layers, which may also be referred to as stack of polymer composite layers. A portion of the metal joining element 344 is positioned between the first set of polymer composite layers 342 and the second set of polymer composite layers 348. The polymer composite layers of the first set of polymer composite layers 342 and the second set of polymer composite layers 348 may be similar in composition and structure to the polymer composite layers described with respect to FIG. 2 and that description is not repeated here.

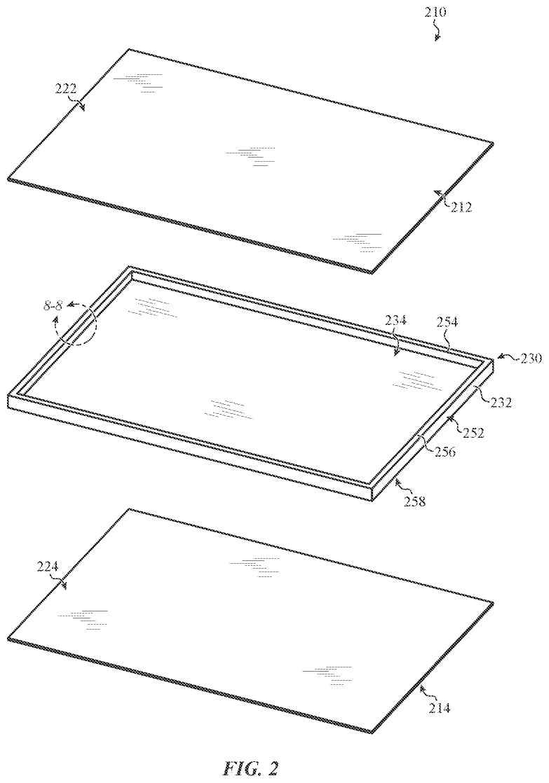

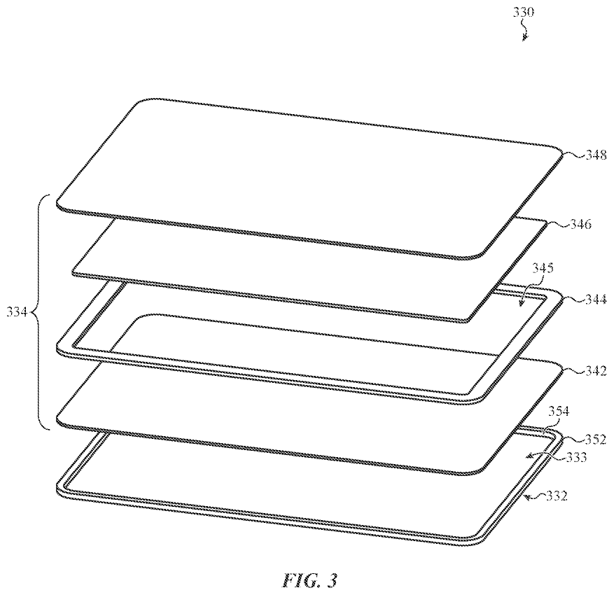

In the example of FIG. 3, the metal joining element 344 defines a ring-like structure (also referred to herein simply as a ring). The metal joining element 344 defines a hole 345. The ring-like structure shown in FIG. 3 is simplified for purposes of illustration and in other embodiments, the metal joining element may take other forms. For example, a metal joining element may define a series of tabs along the periphery as shown and described with respect to FIGS. 4 and 5. As an additional example, a metal joining element may define an interlaced structure extending inwards from the ring-like structure, an example of which is shown and described with respect to FIG. 5. As an additional example, the ring-like structure need not be flat, but can be corrugated or have some other non-planar shape.

The third set of polymer composite layers 346 is configured to fit within the hole 345 and is positioned within the hole when the composite structure 334 is assembled. In some examples, the third set of polymer composite layers 346 fills most or all of the hole. The third set of polymer composite layers 346 may be similar in composition and structure to the polymer composite layers described with respect to FIG. 2 and that description is not repeated here.

The housing component 332 of FIG. 3 defines a band-like structure that in turn defines a hole 333 (alternately, cavity). The housing component 332 defines an exterior surface 352 and an interior surface 354, with the interior surface 354 at least partially defining the hole 333. The housing component 332 of FIG. 3 defines four sides, and therefore the exterior surface 352 includes four exterior side surfaces and the interior surface 354 includes four interior side surfaces. The housing component 332 may also define a wall between the exterior surface 352 and the interior surface 354. In some embodiments, the housing component 332 defines one or more ledges along the interior surface 354, examples of which are shown in FIGS. 1C and 9-13. When assembled, the composite structure 334 fits within the hole 333.

The composite structure 334 may extend between two or more portions of the housing component 332. For example, the composite structure 334 is configured to extend between the left and the right sides of the housing component 332 as shown in FIG. 3. The composite structure 334 may also extend between the forward and the rear sides of the housing component 332 as shown in FIG. 3. As previously described with respect to FIG. 2, the form of the composite structure 334 is not limited to the plate-like form indicated by FIG. 3 and in other embodiments, the composite structure may have a web-like form that defines a plurality of holes. The holes may be configured to accommodate components attached to the front and/or the rear cover assemblies, may provide a via, or the like. A composite structure in the form of such a web can provide additional weight reduction as compared to a metal plate. The composite structure 334 may be coupled to the housing component 332 in a similar manner as previously discussed with respect to FIG. 2.

FIG. 4 shows an example of a metal joining element. The metal joining element 444 defines an array of notches 454 and an array of tabs 452 along the periphery 450. The metal joining component 444 also defines a hole 445 that may be filled with polymer composite layers during assembly of the composite structure. The metal joining element 444 may be formed of any of the metals previously described with respect to FIG. 2. In some instances, the metal joining element 444 may be stamped from a sheet of metal.

After the metal joining element 444 is combined with the polymer composite layers of the composite structure, the tabs 452 may be used to bond the metal joining element 444 to the interior surface of the housing component as previously discussed with respect to FIGS. 1C and 2 and also shown and described at least with respect to FIGS. 9-11. In the example of FIG. 4, the corner regions 456 of the metal joining element 444 are free of notches 454.

FIG. 5 shows another example of a metal joining element. The metal joining element 544 defines an array of notches 554 and an array of tabs 552 along the periphery 550 (but not at the corners 556). In some instances, the metal joining element 544 may be stamped from a sheet of metal.

In contrast to the example of FIG. 4, the metal joining element 544 has a structure 558 extending inwards from the ring 557. In some instances, the structure 558 may be referred to as a central structure. The structure 558 is interlaced and that defines a plurality of holes 545. In some cases, a set of polymer composite layers may be positioned in one or more of these holes 545 during assembly of the composite structure. Alternately or additionally, a polymer material or a single layer of a polymer composite material may be provided in one or more of the holes 545. The polymer composite material (s) and/or polymer material(s) may substantially fill a given hole. The structure 558 of the metal joining element 544 may provide additional stiffness to a central portion of the metal joining element 544 as compared to the metal joining element 444. As a result, the metal joining element 544 may provide additional stiffness to the central portion of the composite structure after the metal joining element 544 is combined with the polymer composite layers of the composite structure. The example of FIG. 5 is not intended to be limiting and interlaced structures of the metal joining element may take other forms. For example, the interlaced structure may define a grid or a lattice. The metal joining element 544 may be formed of any of the metals previously described with respect to FIG. 2 and the tabs 552 may have a similar function as the tabs 452.

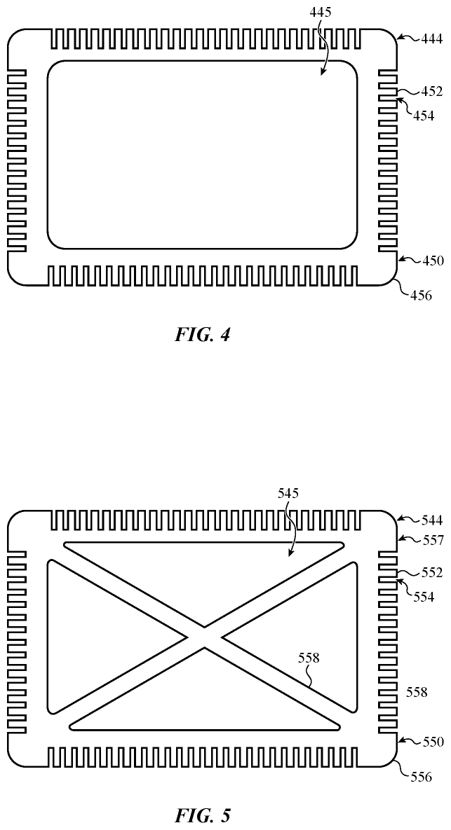

FIG. 6 shows another example of a metal joining element. In contrast to the metal joining element 444 shown in FIG. 4, the metal joining element 644 defines an array of holes 652. The metal joining element 644 may provide additional stiffness to a central portion of the metal joining element 644 as compared to the metal joining element 444. As a result, the metal joining element 644 may provide additional stiffness to the central portion of the composite structure after the metal joining element 644 is combined with the polymer composite layers of the composite structure. In the example of FIG. 6, the holes 652 are shown as defining a circular cross-section, but this example is not intended to be limiting and in additional examples the holes may define cross-sections that are rectangular in shape, triangular in shape, or of any suitable shape. In some instances, the metal joining element 644 may be stamped from a sheet of metal.

In further contrast to the metal joining elements shown in FIGS. 4 and 5, the periphery 650 of the metal joining element 644 does not define an array of notches and tabs. Instead, the periphery of the metal joining element 644 is substantially continuous. In some embodiments, a peripheral portion of the metal joining element need not be bent before insertion within the internal cavity of the electronic device. For example, the metal joining element 644 may be sized to sit on top of a ledge or another attachment features of the housing component and the metal joining element 644 may be simply placed on top of the attachment feature and then bonded to the attachment feature.

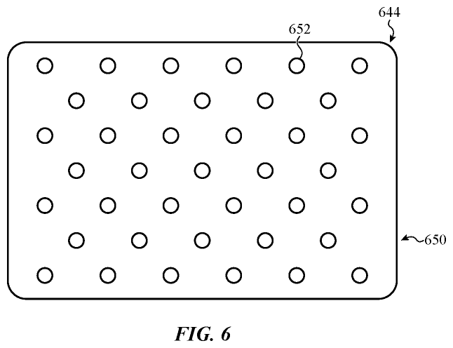

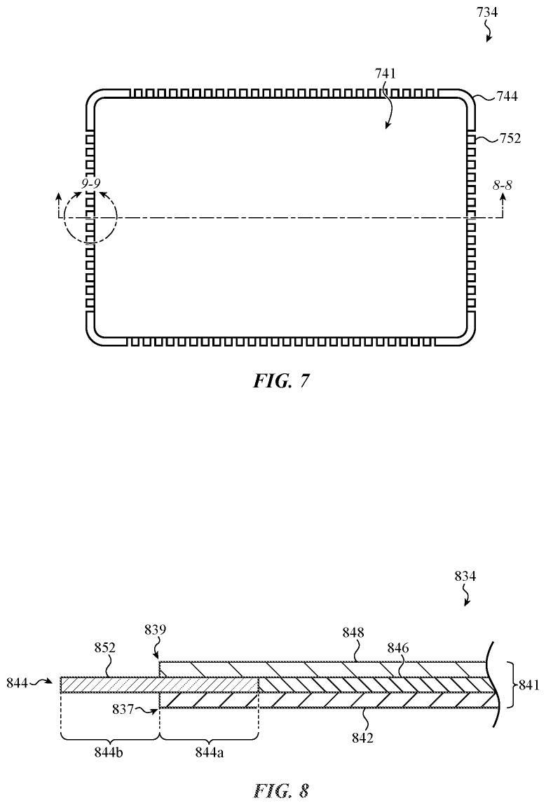

FIG. 7 shows a top view of a composite structure. The composite structure 734 includes a stack of polymer composite layers 741 and a metal joining element 744. A first portion of the metal joining element 744 is positioned within the stack of polymer composite layers 741 (as shown in the cross-section view of FIG. 8). A second portion of the metal joining element 744 extends from the stack of polymer composite layers 741 and includes a plurality of tabs 752.

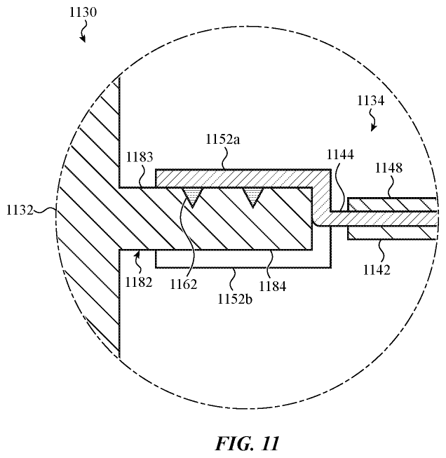

As previously described with respect to FIG. 4, the tabs 752 may be used to bond the metal joining element 744 to an interior surface of the housing component. In some cases, some or all of the tabs 752 may be bent to have a vertical orientation prior to insertion of the composite structure 734 into a housing component. For example, some of the tabs 752 may be bent to have an orientation projecting outward from a plane defined by the top surface of the housing component (as shown in FIG. 7) while other tabs may be bent to have an orientation projecting inward from this plane. As a specific example, adjacent tabs may be bent in opposing directions, which may be accomplished in some embodiments using a double-sided press. This bending operation may facilitate insertion of the composite structure into a housing component having an internal ledge that extends into an internal cavity. The tabs 752 may then be clamped onto the internal ledge so that some of the tabs are clamped to a top of the ledge while other tabs are clamped to a bottom of the ledge examples of which are shown in FIGS. 9 and 11. The clamping operation may also be accomplished with a double-sided press. In some instances, the press heads used for the clamping operation may define an opening sized to accommodate a laser beam used to bond the tabs to the ledge (e.g., via solid-state welding).

The polymer composite layers of the stack of polymer composite layers 741 may be similar in composition and structure to the polymer composite layers described with respect to FIG. 2 and the metal joining element 744 may be similar to the metal joining elements described with respect to FIGS. 2-6 and that description is not repeated here.

FIG. 8 shows a partial cross-sectional view of a composite structure. The cross-sectional view of composite structure 834 may be an example of a cross-section of the composite structure 734 of FIG. 7 along line 8-8. Furthermore, the view of FIG. 8 may be an example cross-sectional view in the detail area 9-9 of FIG. 7.

The composite structure 834 includes a stack of polymer composite layers 841 and a metal joining element 844. The stack of polymer composite layers 841 includes a first set of polymer composite layers 842, a second set of polymer composite layers 848, and a third set of polymer composite layers 846. The polymer composite layers of the first set of polymer composite layers 842, the second set of polymer composite layers 848, and the third set of polymer composite layers 846 may be similar in composition and structure to the polymer composite layers described with respect to FIG. 2 and that description is not repeated here.

A first portion 844a of the metal joining element 844 is positioned within the stack of polymer composite layers 841. A second portion 844b of the metal joining element 844 extends from the stack of polymer composite layers 841. As shown in FIG. 8, the second portion 844b of the metal joining element 844 extends beyond a first edge 837 of the first set of polymer composite layers 842 and a second edge 839 of the second set of polymer composite layers 848. The first edge 837 may generally align with the second edge 839. The second portion 844b of the metal joining element 844 includes a tab 852.

FIG. 9 shows an example of an enlarged view of a housing assembly. The view of FIG. 9 may be a top view of detail area 8-8 of FIG. 2. The housing assembly 930 includes a composite structure 934 coupled to a housing component 932. The composite structure 934 includes a first set of polymer composite layers 948 as part of a stack of polymer composite layers (the rest of the stack is not visible in the view of FIG. 9). The composite structure 934 also includes a metal joining element 944. As previously discussed, a first portion of the metal joining element 944 is positioned within the stack of polymer composite layers and a second portion of the metal joining element 944 protrudes at least with respect to the first set of polymer composite layers 948.

In this example, the tabs 952a and 952b of the metal joining element 944 are coupled to a ledge 982 of the housing component. As shown in FIG. 9, the tabs 952a are positioned on the front surface of the ledge 982 and the tabs 952b are positioned on the rear surface of the ledge 982. In other words, the tabs 952a and 952b are positioned on opposite sides of the ledge 982. In some examples, the tabs 952a and 952b are coupled to the ledge 982 using a solid-state bonding technique or a mechanical interlocking technique to create a metal-to-metal bond between the tabs and the ledge. In other examples, an adhesive may be used to couple the tabs 952a and 952b to the ledge 982.

As previously discussed with respect to FIG. 7, the housing structure 930 may be assembled in part by bending the tabs 952a and 952b before assembling the composite structure 934 with the housing component 932. For example, the tabs 952a may be bent upwards while the tabs 952b may be bent downwards. The tabs 952a and 952b may then be clamped onto the ledge 982 so that the tabs 952a are clamped above the ledge 982 while the tabs 952b are clamped below the ledge. After the tabs 952a and 952b are clamped to the ledge 982 the tabs may be further coupled to the ledge using a solid-state bonding technique, a mechanical interlocking technique, adhesive, or the like. In some instances, the bending of the tabs 952a and 952b can work harden the metal material of the metal joining element 944, thereby increasing the stiffness of the housing structure 930.

The polymer composite layers of the first set of polymer composite layers 948 (and the rest of the stack of polymer composite layers) may be similar in composition and structure to the polymer composite layers described with respect to FIG. 2. The metal joining element 944 may be similar to the metal joining elements described with respect to FIGS. 2-8 and that description is not repeated here. A front surface 966 of the housing component 932 is labeled in FIG. 9 for reference. The housing component 932 may be similar to the housing components described with respect to FIGS. 1A through 3 and that description is not repeated here. For example, the housing component 932 may have a shape that is similar to that shown in FIG. 1C.

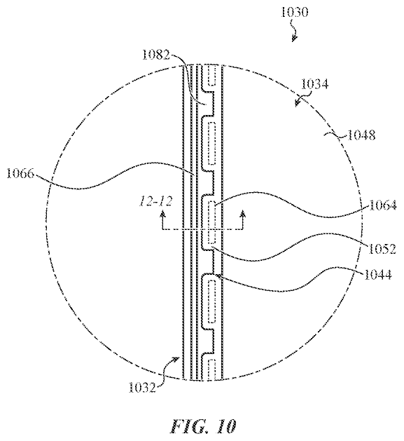

FIG. 10 shows another example of an enlarged view of a housing assembly. The view of FIG. 10 may be a top view of detail area 8-8 of FIG. 2. The housing assembly 1030 includes a composite structure 1034 coupled to a housing component 1032. The composite structure 1034 includes a first set of polymer composite layers 1048 as part of a stack of polymer composite layers (the rest of the stack is not visible in the view of FIG. 10). The composite structure 1034 also includes a metal joining element 1044. As previously discussed, a first portion of the metal joining element 1044 is positioned within the stack of polymer composite layers and a second portion of the metal joining element 1044 protrudes at least with respect to the first set of polymer composite layers 1048.

In this example, the tabs 1052 of the metal joining element 1044 are coupled to a ledge 1082 of the housing component. In the view of FIG. 10, the tabs 1052 are positioned above the ledge 1082. The tabs 1052 may be pressed onto the ledge 1082 before the tabs are coupled to the ledge. As shown in the example of FIG. 10, the operation of coupling the tabs 1052 to the ledge 1082 may form a bond zone 1064, indicated with a dashed line. When the bond zone 1064 is formed by a solid-state bonding technique, the bond zone 1064 may include regions where the metal of the tabs 1052 penetrates into the metal of the ledge 1082. Therefore, the solid-state bonding technique may create micro-scale mechanical interlocks. In some instances, the solid-state bonding technique produces a solid-state weld. In some cases, the solid-state bonding technique may create metal to metal bonding. However, other coupling techniques may also be used as previously described with respect to FIG. 8 and that description is not repeated here.

The polymer composite layers of the first set of polymer composite layers 1048 (and the rest of the stack of polymer composite layers) may be similar in composition and structure to the polymer composite layers described with respect to FIG. 2. The metal joining element 1044 may be similar to the metal joining elements described with respect to FIGS. 2-9 and that description is not repeated here. A front surface 1066 of the housing component 1032 is labeled in FIG. 10 for reference. The housing component 1032 may be similar to the housing components described with respect to FIGS. 1A-3 and 9 and that description is not repeated here. For example, the housing component 1032 may have a shape that is similar to that shown in FIG. 1C.

FIG. 11 shows an example of a partial cross-sectional view through a housing assembly. The view of FIG. 11 may be an example of the view along line 11-11 in FIG. 9. The housing assembly 1130 includes a housing component 1132 and a composite structure 1134 which is attached to a ledge 1182 defined by the housing component 1132. The housing component 1132 may be similar to the housing components described with respect to FIGS. 1A-3 and 9-10 and that description is not repeated here.

The composite structure 1134 includes a metal joining element 1144 and a plurality of polymer composite layers. The plurality of polymer composite layers includes a first set of polymer composite layers 1142 and a second set of polymer composite layers 1148. Although not visible in the magnified view of FIG. 11, the plurality of polymer composite layers may also include a third set of polymer composite layers as was shown in the cross-sectional views of FIGS. 1C and 8. The polymer composite layers of the first set of polymer composite layers 1142, the second set of polymer composite layers 1148, and the polymer composite layers of the third set of polymer composite layers may be similar in composition and structure to the polymer composite layers described with respect to FIG. 2 and that description is not repeated here.

As shown in FIG. 11, the metal joining element 1144 defines tabs 1152a and 1152b. The tab 1152a is bonded to the top surface 1183 of the ledge 1182 and the tab 1152b is bonded to a bottom surface 1184 of the ledge 1182. In the example of FIG. 11, solid state welds 1162 are visible in the plane of the cross-section. The solid-state welds may be formed by a laser welding process, by ultrasonic welding, or by a similar technique. In some cases, individual solid-state welds may be micro-sized, having a diameter or width less than or equal to 100 micrometers. In other cases, the individual solid-state welds may be larger and may have a diameter or width greater than 250 micrometers and less than 1 mm or greater than 500 micrometers and less than 2.5 mm.

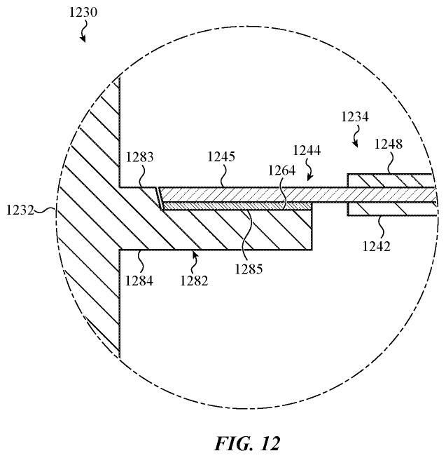

FIG. 12 shows another example of a partial cross-sectional view through a housing assembly. The view of FIG. 12 may be an example of the view along line 12-12 in FIG. 10. The housing assembly 1230 includes a housing component 1232 and a composite structure 1234 which is attached to a ledge 1282 defined by the housing component 1232. The housing component 1232 may be similar to the housing components described with respect to FIGS. 1A-3 and 9-11 and that description is not repeated here.

The composite structure 1234 includes a metal joining element 1244 and a plurality of polymer composite layers. The plurality of polymer composite layers includes a first set of polymer composite layers 1242 and a second set of polymer composite layers 1248. Although not visible in the magnified view of FIG. 12, the plurality of polymer composite layers may also include a third set of polymer composite layers as was shown in the cross-sectional views of FIGS. 1C and 8. The polymer composite layers of the first set of polymer composite layers 1242, the second set of polymer composite layers 1248, and the polymer composite layers of the third set of polymer composite layers may be similar in composition and structure to the polymer composite layers described with respect to FIG. 2 and that description is not repeated here.

As shown in FIG. 12, the ledge 1282 of the housing component 1232 defines a notch portion 1285 along the top surface 1283. The metal joining element 1244 is bonded to the notch portion 1285. In the example of FIG. 12, a bond zone 1264 is formed between the ledge 1282 and the metal joining element 1244. In some cases, the bond zone 1264 may include a solid-state weld. In other cases, the bond zone 1264 may include a fusion bond, such as when the housing component and the metal joining element are formed of similar metals, such as two stainless steel alloys. In some instances, the top surface 1283 of the ledge 1282 and/or the top surface 1245 of the metal joining element 1244 may be machined and/or polished so that the top surfaces are co-planar. The shape of the notch portion 1285 is not limited to the shape shown in FIG. 12 and in additional examples the notch portion may be positioned along the rear surface 1284 of the ledge 1282, the notch portion may define a vertical wall that is substantially perpendicular to horizontal portions of the top or rear surfaces of the ledge, and/or the vertical wall may have a different height relative to the thickness of the ledge 1282 than is shown in FIG. 12.

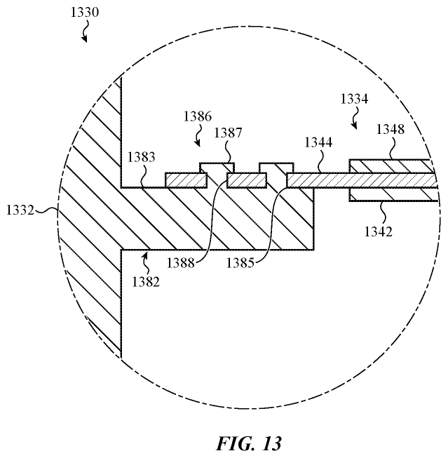

FIG. 13 shows another example of a partial cross-sectional view through a housing assembly. The view of FIG. 13 may be an example of the view along line 12-12 in FIG. 10. The housing assembly 1330 includes a housing component 1332 and a composite structure 1334 which is attached to a ledge 1382 defined by the housing component 1332. The housing component 1332 may be similar to the housing components described with respect to FIGS. 1A-3 and 9-12 and that description is not repeated here.

The composite structure 1334 includes a metal joining element 1344 and a plurality of polymer composite layers. The plurality of polymer composite layers includes a first set of polymer composite layers 1342 and a second set of polymer composite layers 1348. Although not visible in the magnified view of FIG. 13, the plurality of polymer composite layers may also include a third set of polymer composite layers as was shown in the cross-sectional views of FIGS. 1C and 8. The polymer composite layers of the first set of polymer composite layers 1342, the second set of polymer composite layers 1348, and the polymer composite layers of the third set of polymer composite layers may be similar in composition and structure to the polymer composite layers described with respect to FIG. 2 and that description is not repeated here.

In the example of FIG. 13, the housing component 1332 defines features which mechanically engage with features of the metal joining component 1344. As shown in FIG. 13, the ledge 1382 of the housing component 1332 defines protruding features 1386 along a top surface 1383 of the ledge 1382. The metal joining element 1344 defines holes 1385 and the protruding features 1386 extend through the holes. A top portion 1387 of the protruding feature 1386 may have a lateral dimension (such as a width or diameter) that is greater than that of a lower portion 1388 of the protruding feature, which helps to retain the metal joining component 1344 with the housing component 1332. For example, the top portion 1387 may be deformed to increase its lateral dimension after the holes 1385 of the metal joining component are placed over the protruding features 1386. The example of FIG. 13 is not limiting and in additional examples the housing component and the metal joining component may have any of a variety of features that together create a mechanical interlock. For example, the metal joining component may be scored to create a set of hills and valleys and the metal material of the housing component may be deformed around the hills and into the valleys. In some instances, the features creating a mechanical interlock may be macro-sized. As examples, these features may have a characteristic feature size greater than 250 micrometers and less than 1 mm, greater than 500 micrometers and less than 2.5 mm, or greater than 1 mm and less than 5 mm.

FIG. 14 shows another example of a partial cross-sectional view through a housing assembly. The view of FIG. 14 may be an example of the view along line 12-12 in FIG. 10. The housing assembly 1430 includes a housing component 1432 and a composite structure 1434 which is attached to a ledge 1482 defined by the housing component 1432. The housing component 1432 may be similar to the housing components described with respect to FIGS. 1A-3 and 9-13 and that description is not repeated here. The composite structure 1434 may be attached to the ledge by any of the techniques previously described.

The composite structure 1434 includes a metal joining element 1444 and a plurality of polymer composite layers. The plurality of polymer composite layers includes a first set of polymer composite layers 1442 and a second set of polymer composite layers 1448. In the example of FIG. 14, the composite structure 1434 also includes coupling features 1445 and 1455, each of which can be used to couple an internal device component or another component of the enclosure to the composite structure 1434. The coupling features 1445 and 1455 may be at least partially embedded in the plurality of polymer composite layers. As shown in FIG. 14, each of the coupling features 1445 and 1455 are partially embedded in the second set of polymer composite layers 1448. Each of the coupling features 1445 and 1455 protrudes from the composite structure and therefore may be referred to as a boss. However, this example is not limiting and in additional examples coupling features need not protrude from the composite structure (e.g., may be flush with the top surface of the composite structure).

The coupling feature 1445 differs from the coupling feature 1455 since the coupling feature 1445 is defined by the metal joining element 1444 and the coupling feature 1455 is not part of the metal joining element. The coupling feature 1445 may be formed from any of the metals previously described as suitable for the metal joining element. The coupling feature 1455 may be formed from a metal such as steel, a titanium alloy, an aluminum alloy, or a combination thereof and in some cases the coupling feature 1455 may be formed from a different metal than the metal joining element 1444. The example of FIG. 14 is not limiting and in additional examples the composite structure may include only one or more coupling features similar to the coupling feature 1445 or may include only one or more coupling features similar to the coupling feature 1445.

The coupling feature 1445 and the coupling feature 1455 may be configured to allow coupling of an internal device component to the composite structure 1434. For example, each of the coupling feature 1445 and the coupling feature 1455 may be internally threaded. In the example of FIG. 14, the coupling features 1445 and 1455 are configured to allow coupling of an internal device component to a front surface of the composite structure 1434. However, this example is not limiting and in additional examples one or more coupling features may be provided only along the rear surface or along both front and rear surfaces of the composite structure 1434.

Although not visible in the magnified view of FIG. 14, the plurality of polymer composite layers may also include a third set of polymer composite layers as was shown in the cross-sectional views of FIGS. 1C and 8. The polymer composite layers of the first set of polymer composite layers 1442, the second set of polymer composite layers 1448, and the polymer composite layers of the third set of polymer composite layers may be similar in composition and structure to the polymer composite layers described with respect to FIG. 2 and that description is not repeated here.

FIG. 15 shows a block diagram of a sample electronic device that can include a housing assembly as described herein. The schematic representation depicted in FIG. 15 may correspond to components of the devices depicted in FIGS. 1A and 1B as described above. However, FIG. 15 may also more generally represent other types of electronic devices including a housing assembly as described herein.

The device 1500 may also include one or more sensors or sensor components 1520, such as a force sensor, a capacitive sensor, an accelerometer, a barometer, a gyroscope, a proximity sensor, a light sensor, or the like. In some cases, the device 1500 includes a sensor array (also referred to as a sensing array) which includes multiple sensors 1520. For example, a sensor array may include an ambient light sensor, a Lidar sensor, and a microphone. In additional examples, one or more camera components may also be associated with the sensor array. The sensors 1520 may be operably coupled to processing circuitry. In additional examples, the sensors 1520 may include a microphone, an acoustic sensor, a light sensor (including ambient light, infrared (IR) light, ultraviolet (UV) light), an optical facial recognition sensor, a depth measuring sensor (e.g., a time of flight sensor), a health monitoring sensor (e.g., an electrocardiogram (erg) sensor, a heart rate sensor, a photoplethysmogram (ppg) sensor, a pulse oximeter, a biometric sensor (e.g., a fingerprint sensor), or other types of sensing device.

In embodiments, the sensors 1520 provide information regarding configuration and/or orientation of the electronic device in order to control the output of the display. In some embodiments, the sensors 1520 may detect deformation and/or changes in configuration of the electronic device and be operably coupled to processing circuitry that controls the display based on the sensor signals. Example sensors 1520 for this purpose include accelerometers, gyroscopes, magnetometers, and other similar types of position/orientation sensing devices. In some implementations, output from the sensors 1520 is used to reconfigure the display output to correspond to an orientation or folded/unfolded configuration or state of the device. For example, a portion of the display 1508 may be turned off, disabled, or put in a low energy state when all or part of the viewable area of the display 1508 is blocked or substantially obscured. As another example, the display 1508 may be adapted to rotate the display of graphical output based on changes in orientation of the device 1500 (e.g., 90 degrees or 180 degrees) in response to the device 1500 being rotated.

The electronic device 1500 also includes a processor 1506 operably connected with a computer-readable memory 1502. The processor 1506 may be operatively connected to the memory 1502 component via an electronic bus or bridge. The processor 1506 may be implemented as one or more computer processors or microcontrollers configured to perform operations in response to computer-readable instructions. The processor 1506 may include a central processing unit (CPU) of the device 1500. Additionally, and/or alternatively, the processor 1506 may include other electronic circuitry within the device 1500 including application specific integrated chips (ASIC) and other microcontroller devices. The processor 1506 may be configured to perform functionality described in the examples above.

The memory 1502 may include a variety of types of non-transitory computer-readable storage media, including, for example, read access memory (RAM), read-only memory (ROM), erasable programmable memory (e.g., EPROM and EEPROM), or flash memory. The memory 1502 is configured to store computer-readable instructions, sensor values, and other persistent software elements.

The electronic device 1500 may include control circuitry 1510. The control circuitry 1510 may be implemented in a single control unit and not necessarily as distinct electrical circuit elements. As used herein, “control unit” will be used synonymously with “control circuitry.” The control circuitry 1510 may receive signals from the processor 1506 or from other elements of the electronic device 1500.

As shown in FIG. 15, the electronic device 1500 includes a battery 1514 that is configured to provide electrical power to the components of the electronic device 1500. The battery 1514 may include one or more power storage cells that are linked together to provide an internal supply of electrical power. The battery 1514 may be operatively coupled to power management circuitry that is configured to provide appropriate voltage and power levels for individual components or groups of components within the electronic device 1500. The battery 1514, via power management circuitry, may be configured to receive power from an external source, such as an alternating current power outlet. The battery 1514 may store received power so that the electronic device 1500 may operate without connection to an external power source for an extended period of time, which may range from several hours to several days.

In some embodiments, the electronic device 1500 includes one or more input devices 1518. The input device 1518 is a device that is configured to receive input from a user or the environment. The input device 1518 may include, for example, a push button, a touch-activated button, a capacitive touch sensor, a touch screen (e.g., a touch-sensitive display or a force-sensitive display), a capacitive touch button, dial, crown, or the like. In some embodiments, the input device 1518 may provide a dedicated or primary function, including, for example, a power button, volume buttons, home buttons, scroll wheels, and camera buttons.

In some embodiments, the electronic device 1500 includes one or more output devices 1504 configured to provide output to a user. The output device 1504 may include a display 1508 that renders visual information generated by the processor 1506. The output device 1504 may also include one or more speakers to provide audio output. The output device 1504 may also include one or more haptic devices that are configured to produce a haptic or tactile output along an exterior surface of the device 1500.

The display 1508 may include a liquid-crystal display (LCD), a light-emitting diode (LED) display, an LED-backlit LCD display, an organic light-emitting diode (OLED) display, an active layer organic light-emitting diode (AMOLED) display, an organic electroluminescent (EL) display, an electrophoretic ink display, or the like. If the display 1508 is a liquid-crystal display or an electrophoretic ink display, the display 1508 may also include a backlight component that can be controlled to provide variable levels of display brightness. If the display 1508 is an organic light-emitting diode or an organic electroluminescent-type display, the brightness of the display 1508 may be controlled by modifying the electrical signals that are provided to display elements. In addition, information regarding configuration and/or orientation of the electronic device may be used to control the output of the display as described with respect to input devices 1518. In some cases, the display is integrated with a touch and/or force sensor in order to detect touches and/or forces applied along an exterior surface of the device 1500.

The electronic device 1500 may also include a communication port 1512 that is configured to transmit and/or receive signals or electrical communication from an external or separate device. The communication port 1512 may be configured to couple to an external device via a cable, adaptor, or other type of electrical connector. In some embodiments, the communication port 1512 may be used to couple the electronic device 1500 to a host computer.

The electronic device 1500 may also include at least one accessory 1516, such as a camera, a flash for the camera, or other such device. The camera may be part of a camera array or sensing array that may be connected to other parts of the electronic device 1500 such as the control circuitry 1510.

As used herein, the phrase “one or more of” preceding a series of items, with the term “and” or “or” to separate any of the items, modifies the list as a whole, rather than each member of the list. The phrase “one or more of” does not require selection of at least one of each item listed; rather, the phrase allows a meaning that includes at a minimum one of any of the items, and/or at a minimum one of any combination of the items, and/or at a minimum one of each of the items. By way of example, the phrases “one or more of A, B, and C” or “one or more of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The following discussion applies to the electronic devices described herein to the extent that these devices may be used to obtain personally identifiable information data. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
an enclosure defining an internal cavity and comprising:
a housing component defining a set of exterior side surfaces of the electronic device and an internal ledge that extends into the internal cavity of the enclosure;
a composite structure positioned within the internal cavity and comprising:
a first sheet formed from a first polymer composite material;
a second sheet formed from a second polymer composite material; and
a metal joining element comprising:
a first portion positioned between the first sheet and the second sheet; and
a second portion extending from between the first sheet and the second sheet and attached to the internal ledge of the housing component; and
a cover member coupled to the housing component; and
a display positioned within the internal cavity and under the cover member.

2. The electronic device of claim 1, wherein:
the composite structure further comprises a third sheet formed from a third polymer composite material and positioned between the first sheet and the second sheet;
the metal joining element defines a ring that defines a hole; and
the third sheet is positioned within the hole of the metal joining element.

3. The electronic device of claim 2, wherein:
the housing component defines an opening to the internal cavity;
the cover member is positioned within the opening; and
the internal ledge extends around a perimeter defined by an interior surface of the housing component.

4. The electronic device of claim 1, wherein:
the second portion of the metal joining element defines a plurality of tabs; and
each tab of the plurality of tabs is bonded to the internal ledge.

5. The electronic device of claim 4, wherein adjacent tabs of the plurality of tabs are bonded to opposite sides of the internal ledge.

6. The electronic device of claim 1, wherein:
the housing component comprises a member formed from an aluminum alloy;
the metal joining element is formed from steel; and
the member is bonded to the second portion of the metal joining element by a solid-state weld.

7. The electronic device of claim 1, wherein:
the housing component defines a first opening and a second opening opposite to the first opening;
the cover member is a first cover member positioned within the first opening of the housing component;
the electronic device further comprises a second cover member positioned within the second opening of the housing component;
the first cover member defines a front exterior surface of the electronic device; and
the second cover member defines a rear exterior surface of the electronic device.

8. An electronic device comprising:
a display; and
an enclosure at least partially surrounding the display and comprising:
a first transparent member positioned over the display and defining a front exterior surface of the electronic device;
a second transparent member defining a rear exterior surface of the electronic device;
a housing component coupled to the first and the second transparent members and defining a set of side exterior surfaces of the electronic device; and
a composite structure comprising:
a first set of polymer composite layers defining a first edge;
a second set of polymer composite layers defining a second edge; and
a metal joining element comprising:
a first portion disposed between the first and the second sets of polymer composite layers; and
a second portion extending beyond the first and the second edges and coupled to the housing component.

9. The electronic device of claim 8, wherein:
the housing component defines an interior attachment feature; and
the second portion of the metal joining element is bonded to the interior attachment feature of the housing component.

10. The electronic device of claim 9, wherein:
the housing component defines an interior cavity; and
the interior attachment feature extends along a perimeter of the interior cavity.

11. The electronic device of claim 9, wherein:
the first portion of the metal joining element defines an interlaced structure that defines a plurality of holes; and
the composite structure further comprises a third set of polymer composite layers disposed in a hole of the plurality of holes.

12. The electronic device of claim 11, wherein the first portion of the metal joining element defines a grid.

13. The electronic device of claim 8, wherein:
the housing component defines four interior side surfaces; and
the composite structure extends between at least two of the four interior side surfaces.

14. The electronic device of claim 8, wherein:
the second portion of the metal joining element includes an array of tabs; and
each tab of the array of tabs is welded to the housing component.

15. An electronic device comprising:
an enclosure defining an internal cavity and comprising:
a housing component defining an exterior surface of the electronic device and an interior ledge;
a composite structure positioned within the internal cavity and comprising:
a stack of composite layers comprising fibers in a polymer matrix; and
a metal joining element comprising:
a first portion positioned within the stack of composite layers; and
a second portion extending from the stack of composite layers and coupled to the interior ledge; and
a cover member coupled to the housing component; and
a display positioned within the internal cavity and under the cover member.

16. The electronic device of claim 15, wherein:
the housing component defines four interior side surfaces; and
the interior ledge extends along at least two of the four interior side surfaces.

17. The electronic device of claim 16 wherein the second portion of the metal joining element is welded to the interior ledge.

18. The electronic device of claim 16, wherein the second portion of the metal joining element is mechanically interlocked with the interior ledge.

19. The electronic device of claim 15, wherein the metal joining element has a thickness in a range from 0.5 mm to 2 mm.

20. The electronic device of claim 19, wherein the composite structure has a thickness in a range from 0.75 mm to 2.5 mm.
